(19) United States
(12) Patent Application Publication
(10) Pub. No.: US 2003/0013405 A1
(43) Pub. Date: Jan. 16, 2003

(54) Ventilation device and system for vehicles

(76) Inventor: Roger E. Guilford SR., Blue Ridge, GA (US)

Correspondence Address: TECHNOPROP COLTON, L.L.C., P O BOX 567685, ATLANTA, GA, 311567685

(21) Appl. No.: 10/177,421

(22) Filed: Jun. 21, 2002

Related U.S. Application Data
(60) Provisional application No. 60/300,552, filed on Jun. 22, 2001.

(51) Int. Cl. F24F 1/00; H02N 6/00

(52) U.S. Cl. 454/165; 454/900

(57) ABSTRACT

A vehicle ventilation device and system for facilitating air exchange between the interior and exterior of a standing or parked vehicle using a fan and a photoelectric source, whereby said fan is powered by said photoelectric source and said fan is facilitating air exchange between the interior and the exterior of the vehicle through the airbag vent valve of the vehicle.

### STATEMENT OF RELATED APPLICATIONS

This application is based on and claims the benefit of priority on U.S. provisional patent application No. 60/300,552 filed on Jun. 22, 2002.

### BACKGROUND OF THE INVENTION

1. Technical Field

The present invention relates generally to the field of devices and systems to ventilate a vehicle such as a car, truck, trailer, motor home or the like. More specifically, the present invention relates to a powered ventilation system of a type that can ventilate air through an existing air-duct aperture, and that can facilitate the air-exchange between the interior and the exterior of a vehicle.

2. Prior Art.

When a vehicle is left unattended and unventilated in the sun or in a warm environment, temperatures can reach above 1400 Fahrenheit depending on the outside temperature and color of the car. When the vehicle is moving, the engine's alternator provides enough electric power to operate the ventilation-cooling systems such as the automobile's passenger compartment fan. Self-ventilation cooling is also available due to differential air pressure between the interior and the exterior of the vehicle.

When the engine is stopped, the situation is completely different, and there is no electric power available except from the vehicle's battery. Because battery power is very limited, its use for ventilation may drain the battery enough to prevent the vehicle from starting. Thus, when the vehicle is standing, there is little ventilation within the vehicle and the temperature in the vehicle can elevate substantially.

These high temperatures are detrimental to nearly every non-metallic material in the vehicle. The useful life of plastic, rubber, vinyl, and leather is shortened as essential chemicals are broken down. Bonding agents can become brittle and weak. The vehicle's glass windows can be stressed and shattered by the heat. The life of the vehicle is shorted substantially by the detrimental effects of high temperatures.

Most importantly, living creatures cannot withstand temperatures greater than 140° Fahrenheit. Living tissue can be burned when subjected to upholstery or a steering wheel at 140° Fahrenheit. Every summer children and pets are left in unattended vehicles in the sun, and some of them die from the extreme heat. The cooling offered by a photoelectric powered ventilation system could provide a cooler environment in those unfortunate cases by reducing the passenger compartment by 20° or 30° Fahrenheit and could possibly save lives.

Photoelectric powered ventilation systems have been available for several years in vehicles. They can provide efficient and durable cooling systems, which are powered by free solar energy when the vehicle is left unattended in the sun. They can be either thermostatically controlled or more simply controlled by the intensity of the sun, the orientation of the vehicle relative to the sun's position and the photocell. While the source of the systems has primarily been an aftermarket item, some manufacturers have offered factory-installed units. The most popular of these systems is a self-contained system complete with the photoelectric power unit and fan, which installs between a partially opened vehicle window and the window frame. These units are effective in reducing closed vehicle temperatures, but they have met with little success due to several inherent problems:

First, these units have been essentially ineffective in cooling the temperature of the car. The relative small size of the surface area of the units is not large enough for the photoelectric cell to generate enough power to run a fan of sufficient size to move enough air to ventilate the vehicle sufficiently. Due to the small size, the units have not been able to move the heated vehicle air to the outside as fast as the air within the vehicle is heated by the environment. As a consequence, the vehicle continues to get warmer notwithstanding the unit.

Second, these window units have been unsightly. The self-contained unit is very noticeable between on the upper edge of a partially rolled down window class and the edge of the window. Many individuals have not used these devices because they make the vehicle look tacky.

Third, these devices must be installed and removed in the window before and after every use, respectively. If the window is left open sufficiently to provide self-ventilation, it can provide an entrance for rain and it invites burglary. If the device is kept on while the vehicle is in motion or permanently affixed to window, the device will generate a substantial amount of wind noise because the fan is open to the outside. Further, because the window glass essentially holds the device in place, the window glass cannot be rolled down without removing device; if the window glass is rolled down, the device will not be secure in the window. Thus, the consumer is forced to put through a major inconvenience every time she needs to use the device.

Accordingly, there is a need for an efficient, inexpensive device or system that can assist in keeping the interior of a parked or standing vehicle cooler, or at least less warm. It is to this end that the present invention is directed.

### BRIEF SUMMARY OF THE INVENTION

The present invention relates to a device and system for ventilating vehicles. In particular, the present invention is ventilation system that can be powered by a photoelectric cell and can be incorporated into an airbag vent port of the vehicle or into another air-duct port within the vehicle. The device and system can be used to cool (or remove heat from) the interior of the vehicle or to prevent the interior of the vehicle from becoming warm, while the vehicle is standing in a hot environment.

More specifically, the present invention can provide a device and system for the ventilation of a vehicle, which essentially promotes the air-exchange between the interior and the exterior of a vehicle. By facilitating the transfer of the warmer air out of the vehicle, the vehicle is allowed to cool. As the present invention can make use of the secondary function of air bag pressure vents valves as exhaust ports for ventilation of a vehicle by means of powered fan, the device can be fitted or retrofitted relatively easily on vehicles with air bag pressure vents. Further, because airbag pressure vents valves are in hidden locations, the ventilation system of a vehicle can be installed without defacing the vehicle.

The ventilation system of the present invention comprises a ventilation fan, a power source, and a plurality of wires for connecting such components. Preferably, the ventilation fan can comprise an impeller rotated by an electric direct current (DC) motor. The power source preferably is a photoelectric array, in which case ultimately the power is derived from the sun or other light sources. This allows the device and system to operate apart from the electrical system of the vehicle and not be a drain or load on the electrical system of the vehicle. With such a separate power system, the device and system can operate automatically (unattended) and while the vehicle is off (the engine is not running) and not drain the vehicle's battery.

Once the ventilation fan is powered, it can exhaust air from the interior of the vehicle through the airbag pressure relief valve to the exterior of the vehicle. One advantage of using a photoelectric cell or array is that it can be used to charge the vehicle battery when it is not being used to power the ventilation fan. More importantly, this embodiment can be utilized without diminishing the battery power of the vehicle.

In another embodiment, the ventilation system comprises a ventilation fan, a regulating means, and a photoelectric array as a power source. The regulating means signals the ventilation fan to activate and allows the ventilation fan to draw power from the photoelectric array. As in the first embodiment, when the regulating means is not directing the photoelectric array to power to the ventilation fan, the photoelectric array can be used to charge the primary vehicle battery.

The regulating means can be a switch with on and off configurations or a thermostat, wherein the thermostat starts the ventilation fan once the temperature of the interior approaches or passes a preset temperature. Alternatively, the ventilation fan can be set to activate at all times when photoelectric power is available. Other methods to determine when the ventilation fan should activate are understood by persons of ordinary skill in the art and can be selected without undue experimentation.

Further, it is contemplated that embodiments can include a backup battery in the event that photoelectric energy is scarce. The backup battery can be used when energy is not present and can be charged (and recharged) by the photoelectric array. This addition can be accomplished by adding of readily available inexpensive electronic components.

These features, and other objects, features, and advantages of the present invention, are disclosed in more detail and will become more apparent to those of ordinary skill in the art when the following detailed description of the invention is read in conjunction with the accompanying drawings in which like reference characters designate like parts throughout the several views.

### BRIEF DESCRIPTION OF THE FIGURES

FIG. 1 is a schematic representation of one embodiment of the present invention.

FIG. 2 is a side view of the ventilation fan of the embodiment shown in FIG. 1.

FIG. 3 is a schematic representation or a second embodiment of the present invention.

FIG. 4 is an electrical diagram of an embodiment of the present invention.

### DETAILED DESCRIPTION OF THE PREFERRED EMBODIMENTS

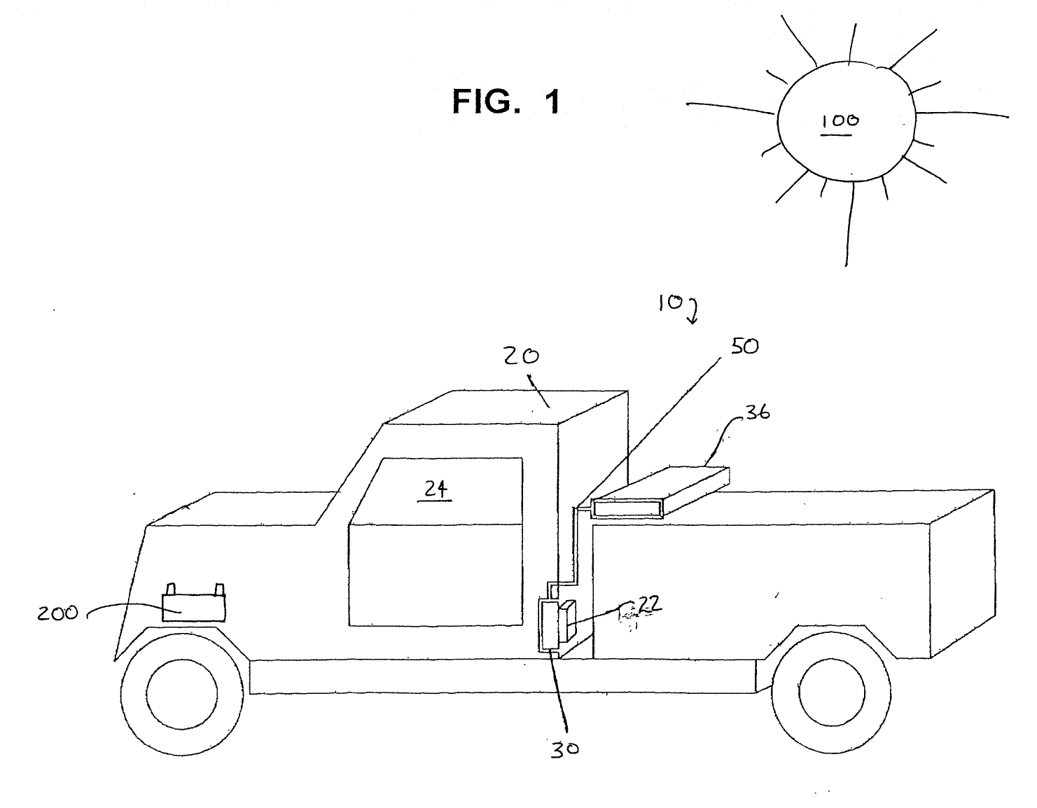

Illustrative embodiments of ventilation system 10 according to the present invention are shown in FIGS. 1 through 4. Although vehicle 20 as shown in the figures is a truck, it is understood that ventilation system 10 may be used on any vehicle, including cars, trucks, motor homes, trailers, and the like. More specifically, preferred embodiments of the present invention are capable of moving air actively between the interior and the exterior of a vehicle in general and can be incorporated into an airbag vent port of a vehicle or into another port within the vehicle. While the invention is described herein in conjunction with the preferred embodiments, it will be understood that the invention is not limited to these embodiments.

Referring now to FIG. 1, a perspective view of a general embodiment of the ventilation system 10 mounted on vehicle 20 is shown. Preferably, ventilation system 10 can be configured to cooperate with an air bag pressure relief valve 22, which is generally present on vehicles 20 with an air bag. Using an air bag pressure relief valve 22 or other port, ventilation system 10 can be used to cool the interior of the car or to prevent the interior of the vehicle from becoming warm while the vehicle is standing in a hot environment by facilitating the exchange of air between the interior and exterior of vehicle 20.

More specifically, ventilation system 10 comprises ventilation fan 30 and power source 36, and a plurality of wires 50 for connecting such components. Preferably, ventilation fan 30 comprises impellers 31 rotated by an electric direct current (DC) motor. Once ventilation fan 30 is powered by power source 36, it exhausts air from the interior 24 of the vehicle 20, through the airbag pressure relief valve 22, to the exterior of the vehicle.

In one embodiment, ventilation system 10 comprises ventilation fan 30 and a photoelectric array as power source 36. In this embodiment, ventilation fan 10 draws power from photoelectric array 36, but ultimately the power is derived from the sun 100 or other light source. Once ventilation fan 10 is powered, it can exhaust air from the interior 24 of the vehicle 20, through the airbag pressure relief valve, to the exterior of the vehicle 20. When the photoelectric array is not powering ventilation fan 30, the photoelectric array can be used to charge the primary vehicle battery 200. One advantage of using a photoelectric array or cell is that it can be used to charge the vehicle battery 200 when it is not in use to power ventilation fan 20. More importantly, this embodiment can be utilized without diminishing the battery power of the vehicle 20. Alternatively, ventilation fan 10 can be electrically connected to and powered by the vehicle battery 200, if desired.

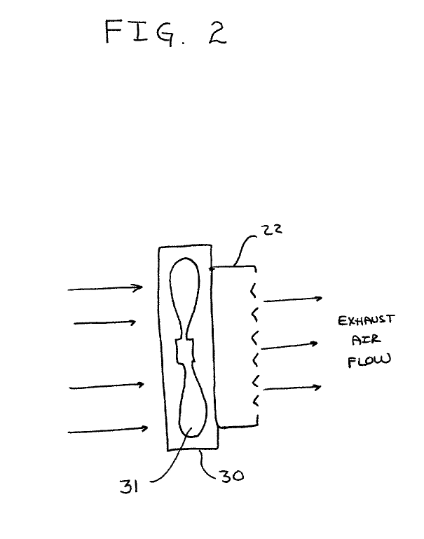

Referring now to FIG. 2, ventilation fan 30 preferably is configured proximally to air bag pressure relief valve 22 so that exhaust air may exit through the airbag pressure relief valve. As shown, ventilation fan 30 can abut air bag pressure relief valve 22 so to allow air to flow directly from interior 60 of vehicle 20 to the exterior of vehicle 20. This embodiment provides for the utilization of pressure vent valves 22 in a secondary function as exhaust ports in continuous powered passenger compartment air ventilation systems.

As air pressure vent valves 22 are routinely installed by vehicle manufacturers in air bag equipped vehicles to prevent high-pressure build up in vehicle passenger compartments resulting from airbag discharges, the system 10 can be installed without having to introduce additional ducts or ports. Hence, ventilation system 10 can thereby maintain the integrity of the passenger compartment by not requiring additional penetrations of the passenger compartment for additional ventilation air exhaust ports.

Ventilation fan 30 can have more than one mode of operation and have variable rates of airflow being created in the different modes of operation. For example, the speed of ventilation fan 30 can be controlled to vary the rate of the airflow created. Ventilation fan 30 may have numerous different designs, which can allow one to selectively change the rate of the airflow.

In another embodiment, ventilation system 10 comprises ventilation fan 30, regulating means 34, and a photoelectric array as power source 36. Regulating means 34 signals ventilation fan 30 to activate and allows ventilation fan 10 to draw power from the photoelectric array 36. When regulating means 34 is not directing the photoelectric array 36 power to the ventilation fan 30, the photoelectric array 36 can be used to charge the primary vehicle battery 200.

Regulating means 34 can be a switch with on and off configurations. This on/off configuration can allow ventilation system 10 to be turned on and off by the user. More specifically, users can activate (or deactivate) ventilation system 10 at desired times by activating switch. These types of switches are obvious to those with ordinary skill in the art.

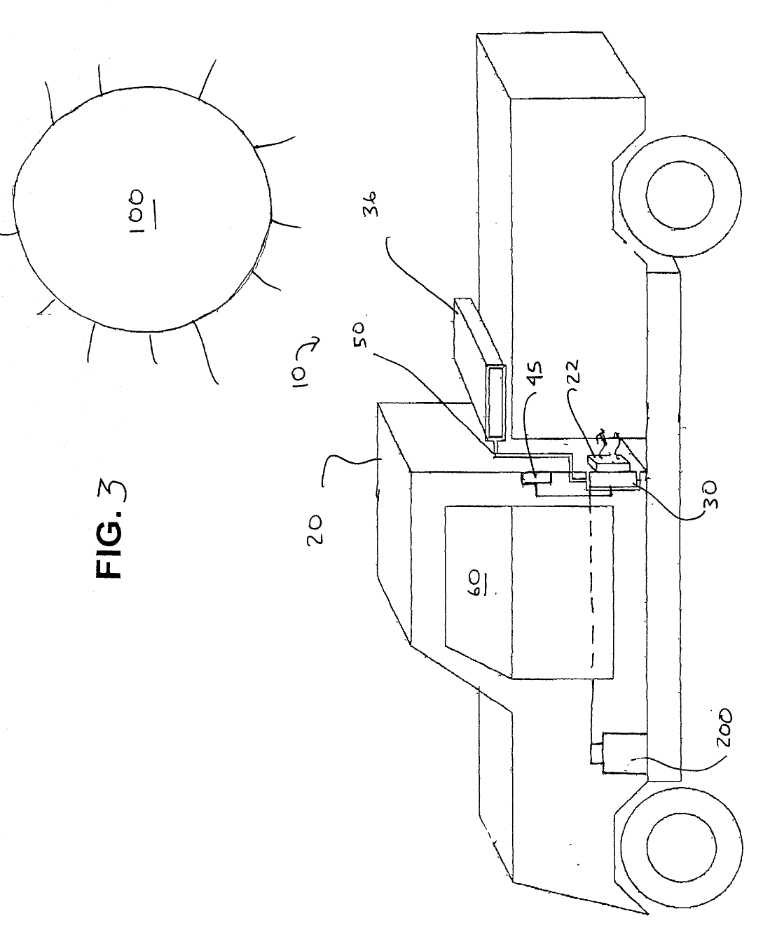

Alternatively, as shown in FIG. 3, regulating means 34 can be thermostat 45. In this embodiment, the temperature of the vehicle is monitored by thermostat 45 and can activate ventilation fan 10 after the interior 60 of the vehicle 20 approaches a set temperature. More particularly, interior air 24 is blown from the interior 60 of the vehicle 20 by ventilation fan 10 when the interior 60 of the vehicle 20 approaches or passes a preset temperature on thermostat 45. It is contemplated that thermostat 45 can be preset by the manufacturer to activate ventilation fan 10 at a set temperature or can be programmed by independent by users of the present invention.

Alternatively, ventilation fan 10 can be set to activate at all times when photoelectric power 100 is available. In this embodiment, ventilation fan 14 is activated by power from the power source. Other methods to determine when ventilation fan 30 should activate are understood by persons of ordinary skill in the art and can be selected without undue experimentation.

Further, it is contemplated that embodiments can include backup battery 50 in the advent that photoelectric energy 100 is scarce. The backup battery 50 can be used when energy is not present and could be charged (and recharged) by photoelectric energy. This addition can be accomplished by adding of readily available inexpensive electronic components.

It is contemplated that ventilation fan 30 could be incorporated into ports different from the airbag vent port 22. For example, an individual could create a port in his or her vehicle 20 to install the present invention and/or aftermarket kits could be used to aid an individual in installing the ventilation fan 30. Alternatively, vehicle manufacturers could install specific ports for this system. This embodiment is particularly useful on vehicles without air bag valve ports.

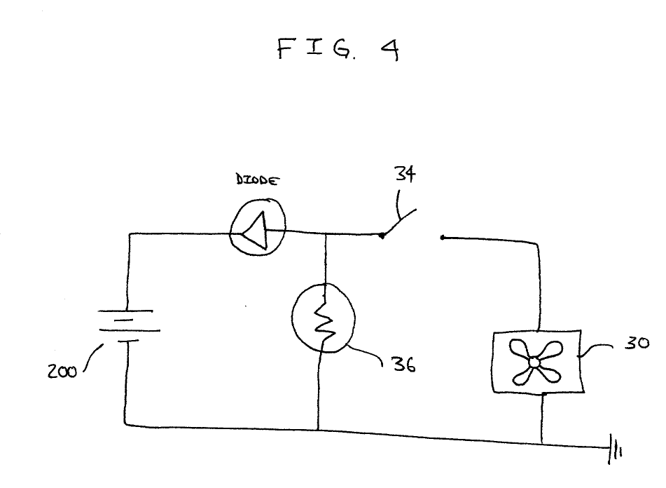

FIG. 4 provides a basic electrical diagram of the electrical interaction between components of one embodiment of the invention. As shown, components can be wired together relatively simply. Other wiring schemes are suitable and can be developed by those of ordinary skill in the wiring arts. The electrical energy is carried to ventilation fan 30 by means of electric conductor cables 50, which can be selected by a person of ordinary skill in the art of electricity. It is envisioned that the ventilation fan 30 can run exclusively or partially on photoelectric energy carried by the conductor cables.

In operation and use, embodiments of the invention can allow users to actively move air from interior of vehicle 20 to the exterior of vehicle 20. More specifically in one embodiment, the user engages regulating means 34, which activates ventilation fan 30. Ventilation fan 30 then actively facilitates air from the interior of vehicle 20 to the exterior of the vehicle 20. When regulating means 34 is disengaged, the air generally stops flowing through ventilation fan 10 and in some cases the power source can charge the vehicle's primary battery 200.

While the invention has been described in connection with certain preferred embodiments, it is not intended to limit the scope of the invention to the particular forms set forth, but, on the contrary, it is intended to cover such alternatives, modifications, and equivalents as can be included within the true spirit and scope of the invention as defined by the appended claims.

What is claimed is:

1. A vehicle ventilation system for facilitating air exchange between the interior and exterior of a vehicle comprising:
a) a ventilation fan configured with an existing port on the vehicle;
b) a power source; whereby the ventilation fan is powered by the power source and the ventilation fan blows air from the interior to the exterior through the existing port.

2. The ventilation system as claimed in claim 1, wherein the power source is a photoelectric power generator.

3. The ventilation system as claimed in claim 2, wherein the power source is placed outside the vehicle.

4. The ventilation system as claimed in claim 1, wherein the existing port is an airbag exhaust port.

5. The ventilation system as claimed in claim 3, wherein the power source and the ventilation fan are connected by means of cables.

6. The ventilation system as claim in claim 4, further comprising a regulating means with an on position and an off position for activating and deactivating the ventilation fan.

7. The ventilation system as claimed in claim 3, further comprising a thermostat with a temperature setting for regulation of the ventilation fan; wherein a temperature above the temperature setting activates the ventilation fan.

8. The ventilation system as claimed in claim 5, wherein the power source is a battery.

9. A vehicle ventilation arrangement for facilitating air exchange between the interior and exterior of a vehicle comprising:
a) a supplemental restraint system ventilation port;
b) a ventilation fan located proximal to the supplemental restraint system ventilation port; and
c) a photoelectric power generator to power the fan, whereby the ventilation fan facilitates air exchange between the interior and the exterior of the vehicle by eliminating air from the interior of the vehicle to the exterior of the vehicle through the ventilation port.

10. The ventilation arrangement as claimed in claim 1, further comprising a thermostat for regulation of the fan.

11. The ventilation arrangement as claimed in claim 1, further comprising a battery as a secondary power source to power said fan.

12. A vehicle ventilation arrangement for facilitating air exchange between the interior and exterior of a vehicle comprising:
a) a supplemental restraint system ventilation port;
b) a ventilation fan located proximal to the supplemental restraint system ventilation port;
c) a photoelectric power generator to power the fan; and
d) a regulating means for regulate the fan, whereby the ventilation fan facilitates air exchange between the interior and the exterior of the vehicle by eliminating air from the interior of the vehicle to the exterior of the vehicle through the ventilation port, and the regulating means regulates the rotational speed of the fan based on a predetermined parameter.

13. The vehicle ventilation arrangement as claimed in claim 12, wherein the ventilation fan, the photoelectric power generator, and the regulating means are connected by a plurality of wiring.

14. The ventilation arrangement as claimed in claim 12, wherein the photoelectric power generator is a plurality of solar panels that converts solar energy into an electric current.

15. The ventilation arrangement as claimed in 12, wherein the regulating means is a switch with an on and an off position.

16. The ventilation arrangement as claimed in 12, wherein the regulating means is a thermostat with a preset parameter.

17. The ventilation arrangement as claimed in 14, wherein the regulating means is the selective exposure of the plurality of solar panels to solar energy.

18. A vehicle ventilation arrangement for facilitating air exchange between the interior and exterior of a vehicle comprising:
a) a supplemental restraint system ventilation port;
b) a fan located proximal to the supplemental restraint system ventilation port;
c) a photoelectric power generator to power the fan;
d) a thermostat to regulate the fan; and
e) a backup battery to power the fan, whereby the fan facilitates air exchange between the interior and the exterior of the vehicle by eliminating air from the interior of the vehicle to the exterior of the vehicle through the ventilation port, the thermostat regulates the rotational speed of the fan based on a predetermined parameter, and the backup battery powers the fan in the absence of a photo source to power the photoelectric power generator
